(19) United States
(12) Patent Application Publication
(10) Pub. No.: US 2026/0208075 A1
(43) Pub. Date: Jul. 23, 2026

(54) DEVICE AND METHOD FOR SEPARATING A LIQUID FROM A FEEDSTOCK

(71) Applicant: HERBOLD MECKESHEIM GMBH, Meckesheim (DE)

(72) Inventor: Holger Watzelt, Neckargemünd (DE)

(21) Appl. No.: 19/137,915

(22) PCT Filed: Dec. 5, 2023
(86) PCT No.: PCT/DE2023/200243

§ 371 Date: Jun. 11, 2025

(30) Foreign Application Priority Data
Dec. 22, 2022 (DE) 10 2022 214 335.3

(51) Int. Cl. B01D 33/11; B01D 33/46; B01D 33/72; B01D 33/76

(52) U.S. Cl. CPC B01D 33/11; B01D 33/461; B01D 33/463; B01D 33/466; B01D 33/72; B01D 33/766

(57) ABSTRACT

The invention relates to a device for separating a liquid from a feedstock, in particular material to be ground or granulate of plastic, having a screen drum (1) comprising a screen drum base (2), a screen drum wall (3) and an outlet side (4) opposite the screen drum base (2), having a feed device (15) for feeding the feedstock into the screen drum (1) and having a discharge device (9) arranged on the outlet side (4) of the screen drum (1) for discharging the feedstock separated from liquid, wherein the screen drum (1) rotates about its centre longitudinal axis (5) and guides off the liquid, characterised in that the feed device (15) has a feed opening arranged on the screen drum base (2) and that a conveying device with at least one conveying element (16) for conveying the feedstock to the outlet side is arranged in the screen drum (1). The method also relates to a method for separating a liquid from a feedstock.

WO

### CROSS REFERENCE TO RELATED APPLICATIONS

This application is a National Stage Application, filed under 35 U.S.C. § 371, of International Application No. PCT/DE2023/200243, filed Dec. 5, 2023, which international application claims priority to and the benefit of German Application No. 10 2022 214 335.3, filed Dec. 22, 2022; the contents of both of which as are hereby incorporated by reference in their entireties.

### BACKGROUND

### Technical Field

The invention relates to an apparatus for separating a liquid from a feedstock, in particular milled material or granules of plastic, having a screen drum that comprises a screen drum bottom, a screen drum wall and an extraction side lying opposite the screen drum bottom, having a supply device for supplying the feedstock into the screen drum and having a discharge device arranged at the extraction side of the screen drum for discharging the feedstock that has been separated from liquid, the screen drum rotating about its central longitudinal axis while draining off liquid. The invention furthermore relates to a method for separating a liquid from the feedstock by using the apparatus.

### Description of Related Art

Besides avoiding waste, the recycling or reuse of recyclable materials that are contained in waste is an essential aspect of coping with a limited amount of resources. The reuse of these recyclable materials makes an important contribution to protecting the environment. There is therefore a great demand to process recyclable materials in such a way that they can be made available for reuse.

In the context of processing plastics, for example used PET bottles or similar types of products, the recycling material is initially comminuted by shredders, cutting mills or other suitable comminuting technology. The milled material resulting from the comminution process is then washed in order to remove adhering residues such as contaminants. For the subsequent steps of the processing, it is necessary to separate the liquid from the cleaned milled material. For this purpose, mechanical dryers are conventionally used.

Mechanical dryers been known in the field for years. According to the current prior art, the separation of a liquid is conventionally carried out by so-called paddle dryers or screw presses. Paddle dryers, in which a rapidly running rotor with striking elements drives the material through a screen basket, are distinguished by a high specific energy requirement and a high material loss rate due to fine abrasion. Screw presses separate the liquid by the material/liquid mixture being pressed through screen tubes with the aid of conveying screws. A problem in this case is that agglomerates are often formed. This may be problematic for carrying out subsequent method steps and therefore necessitate an additional step for separating the agglomerates. Furthermore, the operation of screw presses is generally associated with high wear of the machine.

### BRIEF SUMMARY

The object of the present invention is therefore to configure and develop an apparatus for separating a liquid from a feedstock, in particular milled material or granules of plastic, in such a way that the liquid can be separated energy-efficiently, and with simple means and with the least possible material abrasion/loss as well as apparatus wear. At the same time, a satisfactorily good and homogeneous drying outcome is intended to be achievable. Moreover, the apparatus according to the invention is intended to differ from competing products. A method for separating a liquid from the feedstock by using the apparatus is furthermore intended to be provided. With the aid of the method, it is intended that a drying process can be carried out with continuous supply and discharge of the feedstock.

According to the invention, the aforementioned object is achieved by the features of the accompanying claims.

The apparatus mentioned in the introduction is characterized in that the supply device has a supply opening arranged at the screen drum bottom and in that a conveyor device having at least one conveying element for conveying the feedstock to the extraction side is arranged in the screen drum.

According to the invention, it has been firstly discovered that particularly simple and gentle drying of the feedstock is made possible by using the centrifugal force that occurs as a result of the screen drum rotation. By the centrifugal forces, the wet feedstock that the supply device can supply to the screen drum at the screen drum bottom is pressed onto the screen drum wall. The screen drum wall is configured so that the liquid, but not the feedstock, can be drained off. No forces are therefore applied to the feedstock with mechanical means in order to separate the liquid. This achieves extremely low fine abrasion and material loss, as well as low apparatus wear. It is also associated with a low energy input into the feedstock, so that the energy consumption of the apparatus in question is very low in comparison to previous mechanical dryers.

Furthermore, it has been discovered that a sufficiently long residence time of the feedstock in the screen drum is necessary for a satisfactorily good and homogeneous drying outcome. This is achieved in that the supply device can supply the feedstock to the screen drum at the screen drum bottom. For this purpose, a supply opening is arranged at the screen drum bottom. By the conveyor device arranged in the screen drum, the feedstock can then be conveyed continuously from the screen drum bottom to the extraction side, where it is extracted in the radial and tangential direction and can be discharged by the discharge device. While it is being conveyed to the extraction side, the feedstock is also circulated continuously so that the formation of agglomerates is prevented. Advantageously, the screen drum wall has a cylindrical or conical shape. This allows a particularly simple and economical configuration of the apparatus. A conical shape is advantageous insofar as the feedstock is conveyed as a result of centrifugal forces along the screen drum wall to an end side of the drum.

The central longitudinal axis of the screen drum may advantageously be arranged orthogonally with respect to the screen drum bottom and vertically. The feedstock is pressed onto the screen drum wall while being distributed uniformly in the circumferential direction by the horizontally acting centrifugal force and the vertically acting gravitational force and is extracted at the extraction side. This achieves a particularly homogeneous drying outcome. This arrangement of the central longitudinal axis also allows a particularly simple design of the apparatus, and in particular a simple arrangement of the supply device.

Further advantageously, the supply device may be configured so that the feedstock can be supplied to the screen drum by gravity and/or by a conveyor means. Depending on the arrangement of the supply device, it may be possible to supply the feedstock to the screen drum only by gravity. This achieves a particularly simple and economical design. It is also conceivable that the supply device has a conveyor means in order to supply the feedstock at least locally against the force of gravity or to prevent clogging of the supply device.

The supply device may also comprise a hollow profiled section, the hollow profiled section projecting from the extraction side into the screen drum. The closed profiled section particularly straightforwardly makes it possible that the feedstock can be supplied to the screen drum at the screen drum bottom and that the feedstock is mixed for the first time there with the feedstock already contained in the screen drum.

It is furthermore conceivable that at least one conveying element is configured as a conveying screw or as a guide vane. A rotating conveying screw makes it possible to convey the feedstock particularly uniformly in the direction of the extraction side and at the same time circulate it. The longitudinal axis of the conveying screw is preferably arranged parallel to the central longitudinal axis of the screen drum. In order to improve the conveying and circulation, the conveying screw may also have an opposite direction of rotation to the direction of rotation of the screen drum. Configuring a conveying element as a guide vane represents a particularly simple design configuration of the conveyor device. In contrast to the conveying screw, continuous operation of the conveying element with the aid of a drive is not necessary. The guide vane is inclined so that the feedstock is conveyed from the screen drum bottom to the extraction side as a result of the rotation of the screen drum.

A position of each conveying element in relation to the central longitudinal axis of the screen drum may be regulatable individually in the radial direction. This makes it possible to convey the feedstock purposely into a particular region of the screen drum and to ensure similar residence times of the feedstock. The homogeneity of the drying outcome is thereby increased.

It is particularly advantageous when the conveying speed and/or the conveying direction of each conveying element can also be regulated individually. This may be achieved by adapting a speed of rotation and/or direction of rotation in an embodiment of the conveying element as a conveying screw, or by adapting an angle of inclination in an embodiment of the conveying element as a guide vane. On the one hand, the residence time of the feedstock may thereby be influenced. This is advantageous particularly in order to respond to fluctuating liquid contents of the feedstock. On the other hand, the circulation of the feedstock may be influenced in order to prevent a liquid barrier from being formed internally in front of the holes of the screen drum wall. It is also conceivable that the feedstock is temporarily conveyed back in the direction of the screen drum bottom in order to further increase the circulation.

If the conveyor device has at least two conveying elements, the conveying elements may advantageously be arranged equidistantly from one another or at irregular distances from one another along a circumferential line of a circle. The center of the circle lies on the central longitudinal axis of the screen drum. The conveying elements of the conveyor device may be positioned purposely along the circumferential line so that an imbalance is avoided. This avoids undesired oscillations or vibrations of the screen drum, which for example could have a negative effect on the drying outcome or the service life of the screen drum bearing.

In order to spread out the feedstock at the screen drum bottom, the conveyor device may comprise at least one circulation element. Preferably, a circulation element is configured as a paddlewheel that can be rotated about the central longitudinal axis of the screen drum and is arranged at the screen drum bottom.

Further advantageously, at least one cleaning element may be arranged inside and/or at least one cleaning element may be arranged outside the screen drum, so that it can be applied to the screen drum wall. This prevents the holes of the screen drum wall from being blocked by feedstock, or the liquid drainage being impeded. Particularly advantageously, at least one cleaning element is configured as a brush, a resilient scraper or as a spraying pipe, which can preferably be operated with compressed air and/or liquid. A brush and a resilient scraper are a particularly straightforward and robust means of cleaning. Particularly in the case of feedstock that comprises very small particles, the use of a spraying pipe may be advantageous in relation to the use of a brush or a resilient scraper.

It is also conceivable that a position of each cleaning element can be regulated individually in the radial direction in relation to the central longitudinal axis of the screen drum. The position of the cleaning elements may thereby be adjusted according to the composition of the feedstock so that the cleaning outcome is improved.

A bearing of the screen drum may be arranged at the screen drum bottom and/or at the extraction side. It may be advantageous to arrange a bearing at the screen drum bottom or at the extraction side depending on the design configuration of the apparatus. In the case of relatively large screen drums, a bearing on both sides may be necessary in order to minimize undesired movements of the screen drum in the radial direction or in the longitudinal direction. It is further conceivable that the bearing of the screen drum comprises a resilient clamp and/or a damping means in order to reduce undesired vibrations.

Further advantageously, the discharge device may comprise an attachment having a flange-like collar that encloses the screen drum, an attachment wall and an attachment cover, at least one opening being arranged in the attachment wall and the attachment wall at least partially enclosing the screen drum wall. The feedstock, which is extracted in the radial and tangential direction as a result of the centrifugal forces, is thereby collected and ejected from the apparatus via the opening. Particularly advantageously, the attachment wall may have a cylindrical shape and the discharge device may comprise an annular ejection wheel that is arranged in the attachment. The ejection wheel may be rotatable about the central longitudinal axis of the screen drum and may have at least one transport blade. The at least one transport blade may be configured so that the feedstock ejected at the extraction side can be supplied to the at least one opening. This avoids feedstock accumulating in the discharge device and not being ejected from the opening.

It is also conceivable that a collection device is arranged for collecting and discharging the separated liquid, the collection device at least partially enclosing the screen drum. This avoids the separated liquid being thrown uncontrolledly out of the screen drum.

The method according to the invention uses the apparatus according to the invention. It is characterized in that the feedstock is supplied by the supply device to the screen drum at the screen drum bottom and conveyed by the conveyor device to the extraction side, the screen drum rotating about its central longitudinal axis while draining off liquid, and in that the feedstock is extracted at the extraction side as a result of centrifugal forces and discharged by the discharge device.

A drying process can thereby be carried out with continuous supply and discharge of the feedstock.

### BRIEF DESCRIPTION OF THE FIGURES

There are now various possibilities for advantageously configuring and developing the teaching of the present invention. In this regard, reference is made on the one hand to the claims dependent on claim 1 and on the other hand to the following explanation of preferred exemplary embodiments of the invention with the aid of the drawing. Generally preferred configurations and developments of the teaching are also explained in conjunction with the explanation of the preferred exemplary embodiments of the invention with the aid of the drawing. In the drawing,

FIG. 1 shows an exemplary embodiment of an apparatus according to the invention in a schematic representation with a three-dimensional view,

FIG. 2 shows the exemplary embodiment of FIG. 1 in a schematic sectional representation with a three-dimensional view,

FIG. 3 shows the exemplary embodiment of FIG. 1 in a further schematic sectional representation with a side view, and

FIG. 4 shows the exemplary embodiment of FIG. 1 in a further schematic sectional representation with a plan view.

### DETAILED DESCRIPTION OF VARIOUS EMBODIMENTS

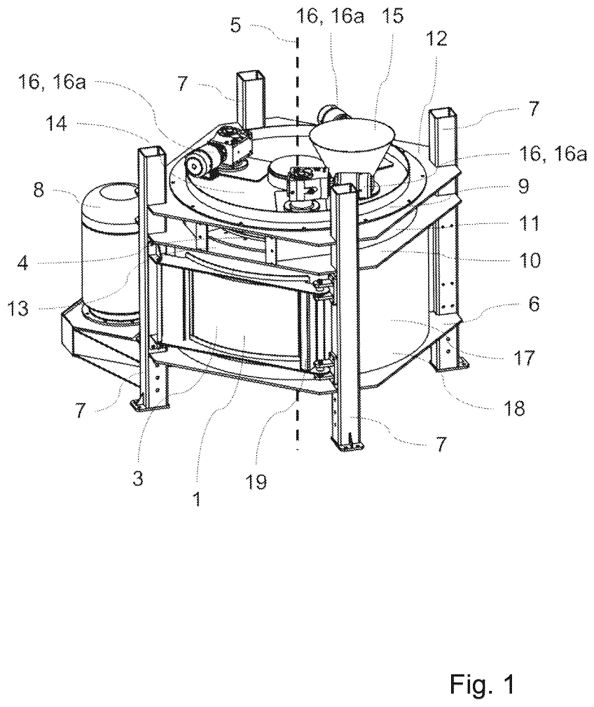

FIG. 1 shows an apparatus according to the invention. It comprises a screen drum 1 having a screen drum bottom 2, a screen drum wall 3 having a cylindrical shape, and an extraction side 4. The screen drum 1 rotates about its central longitudinal axis 5, which is arranged orthogonally with respect to the screen drum bottom 2 and vertically. In this exemplary embodiment, the screen drum 1 is arranged on a base plate 6, a hollow profiled-section support 7 having a foot being fixed to each of the four corner regions of the base plate 6. A drive 8, which sets the screen drum 1 in rotation and keeps the screen drum 1 in motion, is arranged laterally on the apparatus.

Arranged at the extraction side 4, which is positioned at the top in this exemplary embodiment, there is a discharge device 9 for discharging the feedstock. It comprises an attachment having a flange-like collar 10 that encloses the screen drum 1, an attachment wall 11 with a cylindrical shape, and an attachment cover 12. An opening 13, via which the feedstock is ejected from the apparatus, is arranged in the attachment wall 11. The attachment cover 12 comprises a circular plate 14 to which a supply device 15 with a funnel-shaped upper part and three conveying elements 16 are fixed. The conveying elements 16 also each have an individually regulatable drive, which is arranged on the circular plate 14.

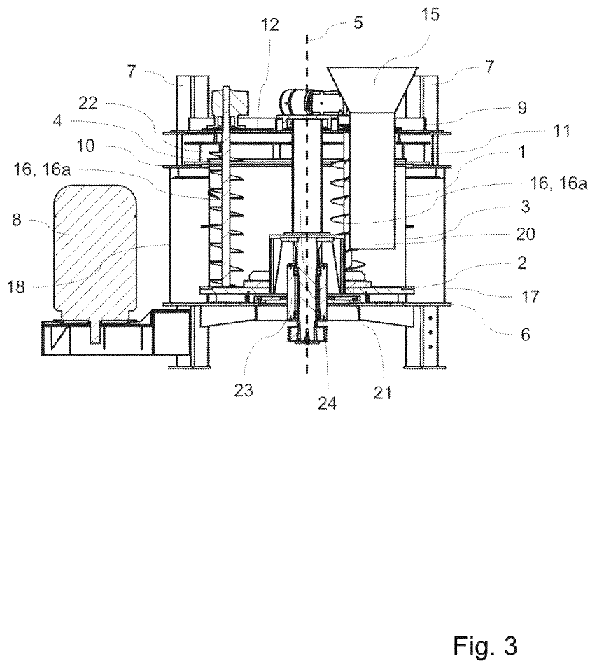

The exemplary embodiment of the apparatus according to the invention further comprises a collection device 17 for collecting and discharging the separated liquid. The collection device 17 has a cylindrical wall 18, which drains off the liquid downward. The liquid is subsequently discharged after having been collected underneath the screen drum 1. It may be seen in FIG. 3 that the wall 18 partially encloses the screen drum 1 and is fixed at the bottom to the base plate 6 and at the top to the flange-like collar 10. The wall 18 of the collection device 17 furthermore comprises an inspection flap 19 with a transparent disk.

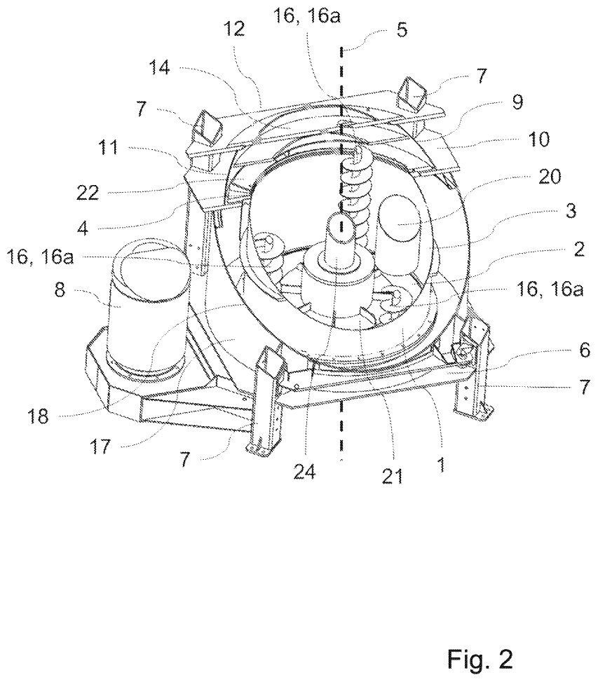

FIGS. 2 and 3 show that, in addition to the funnel-shaped upper part, the supply device 15 comprises a hollow profiled section 20 that projects from the extraction side 4 into the screen drum 1. The lower end of the hollow profiled section 20 constitutes the supply opening, from which the feedstock enters the screen drum 1 at the screen drum bottom 2. The three conveying elements 16 are each configured as a conveying screw 16a, these conveying screws being arranged in the screen drum. A circulation element 21 is furthermore arranged at the screen drum bottom 2. It is configured as a paddlewheel that can be rotated about the central longitudinal axis 5 of the screen drum 1.

The discharge device 9 comprises an annular ejection wheel 22, which is arranged in the attachment, can be rotated about the central longitudinal axis 5 of the screen drum 1 and has a plurality of transport blades. The ejection wheel 22 is arranged at the extraction side 4 on the screen drum 1. The feedstock is supplied to the opening 13 with the aid of the rotating ejection wheel 22.

It may be seen in FIG. 3 that the bearing 23 of the screen drum 1 is embodied by a shaft 24 that is arranged along the central axis 5. The screen drum bottom 2 is fixed to the shaft 24, and the shaft 24 is mounted at the bottom in the base plate 6.

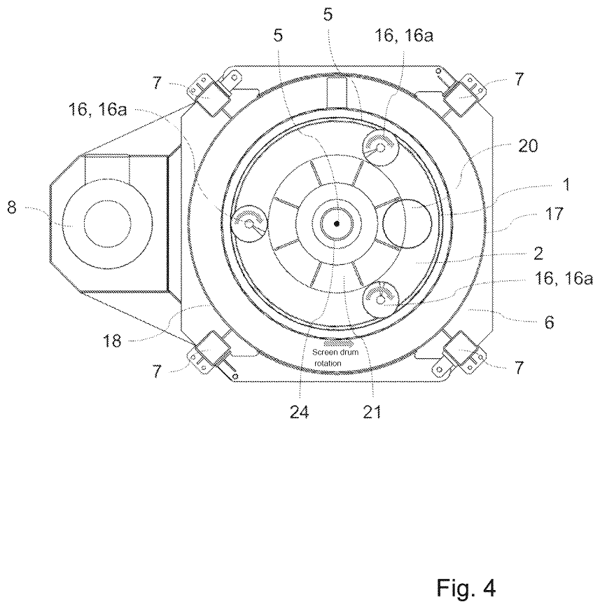

FIG. 4 shows the exemplary embodiment of the apparatus according to the invention in a plan view. The apparatus is represented in a cross section transversely with respect to the central longitudinal axis 5 and below the discharge device 9, so that the three conveying screws 16, the rotatable paddlewheel of the circulation element 21 and the hollow profiled section 20 can be seen. FIG. 4 also indicates the directions of rotation of the conveying screws 16a and of the screen drum 1 using arrows. In this exemplary embodiment, the conveying screws 16a have an opposite direction of rotation to the direction of rotation of the screen drum 1 in order to improve the conveying and circulation of the feedstock.

It is particularly advantageous when the conveying speed and/or the conveying direction of each conveying element can also be regulated individually. This may be achieved by adapting a speed of rotation and/or direction of rotation in an embodiment of the conveying element as a conveying screw, or by adapting an angle of inclination in an embodiment of the conveying element as a guide vane. On the one hand, the residence time of the feedstock may thereby be influenced. This is advantageous particularly in order to respond to fluctuating liquid contents of the feedstock. On the other hand, the circulation of the feedstock may be influenced in order to prevent a liquid barrier from being formed internally in front of the holes of the screen drum wall. It is also conceivable that the feedstock is temporarily conveyed back in the direction of the screen drum bottom in order to further increase the circulation.

If the conveyor device has at least two conveying elements, the conveying elements may advantageously be arranged equidistantly from one another or at irregular distances from one another along a circumferential line of a circle. The center of the circle lies on the central longitudinal axis of the screen drum. The conveying elements of the conveyor device may be positioned purposely along the circumferential line so that an imbalance is avoided. This avoids undesired oscillations or vibrations of the screen drum, which for example could have a negative effect on the drying outcome or the service life of the screen drum bearing.

In order to spread out the feedstock at the screen drum bottom, the conveyor device may comprise at least one circulation element. Preferably, a circulation element is configured as a paddlewheel that can be rotated about the central longitudinal axis of the screen drum and is arranged at the screen drum bottom.

Further advantageously, at least one cleaning element may be arranged inside and/or at least one cleaning element may be arranged outside the screen drum, so that it can be applied to the screen drum wall. This prevents the holes of the screen drum wall from being blocked by feedstock, or the liquid drainage being impeded. Particularly advantageously, at least one cleaning element is configured as a brush, a resilient scraper or as a spraying pipe, which can preferably be operated with compressed air and/or liquid. A brush and a resilient scraper are a particularly straightforward and robust means of cleaning. Particularly in the case of feedstock that comprises very small particles, the use of a spraying pipe may be advantageous in relation to the use of a brush or a resilient scraper.

It is also conceivable that a position of each cleaning element can be regulated individually in the radial direction in relation to the central longitudinal axis of the screen drum. The position of the cleaning elements may thereby be adjusted according to the composition of the feedstock so that the cleaning outcome is improved.

A bearing of the screen drum may be arranged at the screen drum bottom and/or at the extraction side. It may be advantageous to arrange a bearing at the screen drum bottom or at the extraction side depending on the design configuration of the apparatus. In the case of relatively large screen drums, a bearing on both sides may be necessary in order to minimize undesired movements of the screen drum in the radial direction or in the longitudinal direction. It is further conceivable that the bearing of the screen drum comprises a resilient clamp and/or a damping means in order to reduce undesired vibrations.

Further advantageously, the discharge device may comprise an attachment having a flange-like collar that encloses the screen drum, an attachment wall and an attachment cover, at least one opening being arranged in the attachment wall and the attachment wall at least partially enclosing the screen drum wall. The feedstock, which is extracted in the radial and tangential direction as a result of the centrifugal forces, is thereby collected and ejected from the apparatus via the opening.

Particularly advantageously, the attachment wall may have a cylindrical shape and the discharge device may comprise an annular ejection wheel that is arranged in the attachment. The ejection wheel may be rotatable about the central longitudinal axis of the screen drum and may have at least one transport blade. The at least one transport blade may be configured so that the feedstock ejected at the extraction side can be supplied to the at least one opening. This avoids feedstock accumulating in the discharge device and not being ejected from the opening.

It is also conceivable that a collection device is arranged for collecting and discharging the separated liquid, the collection device at least partially enclosing the screen drum. This avoids the separated liquid being thrown uncontrolledly out of the screen drum.

In respect of further advantageous configurations of the apparatus according to the invention, reference is made to the general part of the description and the appended claims in order to avoid repetitions.

Lastly, it should expressly be pointed out that the above-described exemplary embodiment of the apparatus according to the invention merely serves to discuss the claimed teaching but does not restrict it to the exemplary embodiment.

1. An apparatus for separating a liquid from a feedstock, in particular milled material or granules of plastic, having a screen drum (1) that comprises a screen drum bottom (2), a screen drum wall (3) and an extraction side (4) lying opposite the screen drum bottom (2), having a supply device (15) for supplying the feedstock into the screen drum (1) and having a discharge device (9) arranged at the extraction side (4) of the screen drum (1) for discharging the feedstock that has been separated from liquid, the screen drum (1) rotating about its central longitudinal axis (5) while draining off liquid, wherein the supply device (15) has a supply opening arranged at the screen drum bottom (2) and in that a conveyor device having at least one conveying element (16) for conveying the feedstock to the extraction side is arranged in the screen drum (1).

2. The apparatus as claimed in claim 1, wherein the screen drum wall (3) has a cylindrical or conical shape.

3. The apparatus as claimed in claim 1, wherein the central longitudinal axis (5) of the screen drum (1) is arranged orthogonally with respect to the screen drum bottom (2) and vertically.

4. The apparatus as claimed in claim 1 wherein the supply device (15) is configured so that the feedstock can be supplied to the screen drum (1) by gravity and/or by a conveyor means.

5. The apparatus as claimed in claim 1, wherein the supply device comprises a hollow profiled section (20), the hollow profiled section (20) projecting from the extraction side (4) into the screen drum (1).

6. The apparatus as claimed in claim 1, wherein at least one conveying element (16) is configured as a conveying screw (16a) or as a guide vane.

7. The apparatus as claimed in claim 1, wherein a position of each conveying element (16) in relation to the central longitudinal axis (5) of the screen drum (1) can be regulated individually in the radial direction.

8. The apparatus as claimed in claim 1, wherein the conveying speed and/or the conveying direction of each conveying element (16) can be regulated individually, preferably by adapting a speed of rotation and/or direction of rotation in an embodiment of the conveying element (16) as a conveying screw (16a) or by adapting an angle of inclination in an embodiment of the conveying element (16) as a guide vane.

9. The apparatus as claimed in claim 1, wherein at least two conveying elements (16) are arranged, the conveying elements (16) being arranged equidistantly from one another or at irregular distances from one another along a circumferential line of a circle, the center of the circle lying on the central longitudinal axis (5) of the screen drum (1).

10. The apparatus as claimed in claim 1, wherein the conveyor device comprises at least one circulation element (21) for distributing the feedstock, the circulation element (21) preferably being configured as a paddlewheel that can be rotated about the central longitudinal axis (5) of the screen drum (1).

11. The apparatus as claimed in claim 1, wherein at least one cleaning element is arranged inside and/or at least one cleaning element is arranged outside the screen drum (1), so that it can be applied to the screen drum wall (3).

12. The apparatus as claimed in claim 11, wherein at least one cleaning element is configured as a brush, as a resilient scraper or as a spraying pipe, which can preferably be operated with compressed air and/or liquid.

13. The apparatus as claimed in claim 11, wherein position of each cleaning element can be regulated individually in the radial direction in relation to the central longitudinal axis (5) of the screen drum (1).

14. The apparatus as claimed in claim 1, wherein a bearing (23) of the screen drum (1) is arranged at the screen drum bottom (2) and/or at the extraction side (4).

15. The apparatus as claimed in claim 14, wherein the bearing (23) of the screen drum (1) comprises a resilient clamp and/or a damping means.

16. The apparatus as claimed in claim 1, wherein the discharge device (9) comprises an attachment having a flange-like collar (10) that encloses the screen drum (1), an attachment wall (11) and an attachment cover (12), at least one opening (13) being arranged in the attachment wall (11) and the attachment wall (11) at least partially enclosing the screen drum wall (3).

17. The apparatus as claimed in claim 16, wherein the attachment wall (11) has a cylindrical shape and the discharge device (9) comprises an annular ejection wheel (22) that is arranged in the attachment, the ejection wheel (22) being rotatable about the central longitudinal axis (5) of the screen drum (1) and having at least one transport blade, the at least one transport blade being configured so that the feedstock ejected at the extraction side (4) can be supplied to the at least one opening (13).

18. The apparatus as claimed in claim 1, wherein a collection device (17) is arranged for collecting and discharging the separated liquid, the collection device (17) at least partially enclosing the screen drum (1).

19. A method for separating a liquid from a feedstock, in particular milled material or granules of plastic, by using an apparatus as claimed in claim 1, wherein the feedstock is supplied by the supply device (15) to the screen drum (1) at the screen drum bottom (2) and conveyed by the conveyor device to the extraction side (4), the screen drum (1) rotating about its central longitudinal axis (5) while draining off liquid, and in that the feedstock is extracted at the extraction side as a result of centrifugal forces and discharged by the discharge device (9).
